(19) United States
(12) Patent Application Publication
(10) Pub. No.: US 2026/0260262 A1
(43) Pub. Date: Sep. 3, 2026

(54) USING COMPARATIVE STATISTICAL TESTS TO RANK CONTENT ATTRIBUTE VALUES FOR A TARGET AUDIENCE

(71) Applicant: ADOBE INC., San Jose, CA (US)

(72) Inventors: Biswanath HALDER, Bangalore (IN); Kunal Kumar JAIN, Chennai (IN)

(21) Appl. No.: 19/066,465

(22) Filed: Feb. 28, 2025

(51) Int. Cl. G06Q 30/0242; G06Q 10/0639; G06Q 30/0241

(52) U.S. Cl. CPC G06Q 30/0243; G06Q 10/06393; G06Q 30/0276

(57) ABSTRACT

Methods and systems are provided for using comparative statistical tests to rank content attribute values for a target audience. In embodiments described herein, historical content and corresponding historical performance metrics are accessed. Attribute values of content attributes are determined from the historical content. A ranked set of content attributes is determined based on a computed impact of the attribute values of a particular content attribute on the corresponding historical performance metric. A ranked set of attribute values is determined by scoring each attribute value using a comparative statistical test to compare the historical performance metric of each content asset with the attribute value to the historical performance metric of each remaining content asset without the attribute value. The ranked set of content attributes and the ranked set of attribute values are displayed or utilized by a generative artificial intelligence model to generate content.

### BACKGROUND

Marketers track different key performance indicators (KPIs), such as click through rate (CTR), cost per click (CPC), and/or the like, to evaluate the efficacy of their marketing strategy. In order to develop marketing content, marketers manually apply their personal domain knowledge when developing marketing content to subjectively assess whether the advertisement campaigns will be effective at resonating with a target audience. As such, the digital marketer must manually experiment and subjectively refine the marketing content in order to develop marketing content that meets the desired KPIs for the marketing content.

### SUMMARY

Various aspects of the technology described herein are generally directed to systems, methods, and computer storage media for, among other things, using comparative statistical tests to rank content attribute values for a target audience. For example, historical content and corresponding historical performance metrics of the historical content are accessed. Attribute values of content attributes, such as detected foreground colors or detected objects in each content asset of the historical content, are determined from the historical content using machine learning models trained to extract the attribute values. A ranked set of content attributes is determined by scoring each content attribute based on a computed impact of the corresponding attribute values of a particular content attribute on the corresponding historical performance metric. A ranked set of attribute values is determined by scoring each attribute value using a comparative statistical test, such as analysis of variance (ANOVA) or a Kruskal-Wallis test, which compares the corresponding historical performance metric of content assets that have the attribute value to the corresponding historical performance metric of the content assets that do not have the attribute value. The ranked set of content attributes and the ranked set of attribute values that indicate the importance of particular content attributes and particular attribute values can be displayed to a user and/or utilized by a generative artificial intelligence model to generate content to increase the KPIs of the content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIG. 3 is a process flow showing a method for implementing using comparative statistical tests to rank content attribute values for a target audience, in accordance with embodiments of the present disclosure.

FIG. 4 is a process flow showing a method for implementing using comparative statistical tests to rank content attribute values for a target audience, in accordance with embodiments of the present disclosure.

FIG. 5 is a block diagram of an example computing device in which embodiments of the present disclosure can be employed.

### DETAILED DESCRIPTION

Various terms are used throughout the description of embodiments provided herein. A brief overview of such terms and phrases is provided here for ease of understanding, but more details of these terms and phrases is provided throughout.

A “comparative statistical test” (also referred to herein as a “comparative statistical model”), such as Analysis of Variance (ANOVA) and the Kruskal-Wallis test, generally refer to statistical models used to evaluate differences among groups in various datasets. ANOVA is a parametric test that compares the means of two or more groups to determine if significant differences exist. ANOVA analyzes the ratio of between-group variance to within-group variance under the assumption of normally distributed data, equal variances, and independent observations. The Kruskal-Wallis test is a non-parametric test that evaluates differences in medians across two or more independent groups by ranking all data points and analyzing the rank sums. The Kruskal-Wallis test is typically utilized for datasets that violate assumptions of the parametric models, such as ANOVA.

A “marketing performance metric” (also referred to herein as a “performance metric” or a “key performance indicator (KPI)”) is a measurement used in digital marketing to evaluate the efficacy of the marketing content. For example, “Click Through Rate (CTR)” generally refers to a marketing performance metric used to evaluate the effectiveness of marketing content, such as digital advertisements, in driving user engagement. CTR is calculated as the percentage of users who click on the marketing content, such as a link in the digital advertisement, with respect to the number of impressions of the marketing content. A higher CTR indicates that the marketing content has higher engagement and relevance to the target audience, whereas a lower CTR may suggest that the marketing content should be changed. As another example, “Cost Per Click (CPC)” generally refers to a performance metric that measures the cost an advertiser pays each time someone clicks on the marketing content. CPC allows an advertiser to evaluate the efficacy of the marketing content based on the return on investment (ROI) for the advertising campaign based on the corresponding marketing content.

An “advertisement platform” generally refers to a platform that stores, delivers, and tracks digital advertisements across different communication channels. The advertisement platform can determine advertisements to show to a specific customer and/or customer device based on customer data, targeting criteria, and/or any criteria of an advertisement campaign. The advertisement platform can also track performance metrics, such as CTR, CPC, impressions, clicks, conversions, and/or the like to optimize an advertisement campaign. An example of an advertisement platform is Adobe® Advertising Cloud (AdCloud).

“Customer data” refers to any data regarding a customer or customers, such data regarding interaction between a customer and an advertisement on a customer device. A “customer data source” refers to a data store that stores customer data of a particular set of customers, such as customers of a particular business or brand of a business. Customer data within a dataset may include, by way of example and not limitation, data that is sensed or determined from one or more sensors, such as location information of mobile device(s), smartphone data (such as phone state, charging data, date/time, or other information derived from a smartphone), activity information (for example: app usage; online activity; searches; browsing certain types of webpages; listening to music; taking pictures; voice data such as automatic speech recognition; activity logs; communications data including calls, texts, instant messages, and emails; website posts; other user data associated with communication events) including activity that occurs over more than one device, user history, session logs, application data, contacts data, calendar and schedule data, notification data, social network data, news (including popular or trending items on search engines or social networks), online gaming data, ecommerce activity, including customer journey data, sports data, health data, customer demographics, customer's geographical location, economic status, customer gender, customer age, or any other relevant demographic data collected regarding the customer, and nearly any other source of data that may be used to identify the customer.

A “customer device” generally refers to an electronic device that is used by a customer where an application operating on the electronic initiates advertisement requests for targeted advertisements and the customer interacts with the targeted advertisements. For example, a customer device may refer to a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

“Content attributes” (also referred to herein as “marketing attributes”) generally refer to characteristics or features of marketing content (e.g., advertisements) that influence the perception and effectiveness of the content. For example, text-based content attributes include content attributes, such as readability, persuasion strategy, content emotions, tones, narratives, keywords, words count, sentences count, hash tags count, stop words ratio, and/or the like. As another example, image-based content attributes including content attributes, such as foreground colors, background colors, tags, scenes, objects, people categories, image styles, and/or the like. As another example, video-based content attributes include content attributes, such as audio type, audio genre, audio mood, camera position, lighting conditions, and/or the like. “Content attribute values” (also referred to herein as “attribute values”) refers to the particular value of the content attribute. For example, if the content attribute is “foreground color,” the attribute values can be “red,” “white,” “blue,” etc. As another example, if the content attribute is “readability,” the attribute values could be “low readability,” “medium readability, or “high readability.”

### Overview

As described above, marketers track different KPIs, such as CTR, CPC, and/or the like, to evaluate the efficacy of their marketing strategy. In order to develop marketing content, marketers manually apply their personal domain knowledge when developing marketing content to subjectively assess whether the advertisement campaigns will be effective at resonating with a target audience. As such, the digital marketer must manually experiment and subjectively refine the marketing content in order to develop marketing content that increases the desired KPIs for the marketing content.

Accordingly, unnecessary computing resources are utilized to manually experiment and subjectively refine the marketing content in conventional implementations. For example, computing and network resources are unnecessarily consumed in an effort to facilitate manually experimenting and subjectively refining marketing content to initiate multiple advertising campaigns based on the different marketing content in order to find marketing content that increases the desired KPIs. For instance, computer input/output operations are unnecessarily increased in order to initiate multiple advertising campaigns based on different marketing content as each advertising campaign requires a significant amount of computer input/output operations related to serving advertisements. Further, as the advertising campaigns are communicated over a network, initiating multiple advertising campaigns based on different marketing content to increase the desired KPIs decreases the throughput for the network, increases the network latency, and increases packet generation costs.

Further, in certain instances, while content attribute values and/or content attributes can be ranked using predictive models, such as regression models and/or ML models, the predictive models require extensive training data in order to accurately predict the ranking of the content attribute values and/or content attributes. As a result, when the extensive training data required to accurately predict the ranking is not available, the predictive models provide inaccurate results. When the extensive training data required to accurately predict the ranking is available, the extensive training data unnecessarily consumes computing and network resources to store and process the data to train the predictive models. Thus, using predictive models, such as regression models and/or ML models, to predict the ranking of the content attribute values and/or content attributes unnecessarily consume computing and network resources in certain instances as the predictive models either provide inaccurate results when there is not enough training data or unnecessarily consume computing and network resources when there is enough training data.

As such, embodiments of the present disclosure are directed to using comparative statistical tests to rank content attribute values for a target audience in an efficient and effective manner. By ranking content attributes of marketing content for a target audience using comparative statistical tests, the KPIs of the marketing campaign can be efficiently and effectively improved using the higher ranked content attributes while minimizing the necessary computing and networking resources required to accurately rank the content attributes for the target audience.

Generally, and at a high level, embodiments described herein facilitate using comparative statistical tests to rank content attribute values for a target audience. For example, historical content and corresponding historical performance metrics of the historical content are accessed. Attribute values of content attributes, such as detected foreground colors or detected objects in each content asset of the historical content, are determined from the historical content using machine learning models trained to extract the attribute values.

In this regard, a ranked list of content attributes and a ranked list of attribute values of each of the content attributes are determined based on the corresponding historical performance metrics of the historical marketing content in order to indicate the content attributes and attribute values that result in a higher KPI. As an example, for a set for image-based historical marketing content, twenty content attributes are extracted. The five most important content attributes (e.g., the top subset of the ranked content attributes) with respect to a higher CTR value are determined. For instance, the five most important content attributes are determined to be foreground color, background color, image tags, overall tone and image style. For each of the five most important content attributes, the attribute values of each of the content attributes that result in the highest CTR values are determined. For instance, foreground color may have ten values, such as red, green, orange, black, white, etc. In this regard, the attribute values are ranked in order to provide prescriptive insights, such as a prescriptive insight indicating that red is better than green as a foreground color based on the historical performance metrics of the marketing content.

Continuing with the high level overview, in certain embodiments, a ranked set of content attributes, or a top subset thereof, is determined by scoring each content attribute based on a computed impact of the corresponding attribute values of a particular content attribute on the corresponding historical performance metric. The impact score for the particular content attribute can be computed based on a weighted sum of (1) an absolute gain score; (2) a Kullback-Leibler (KL) divergence score; and (3) a comparative statistical test score.

The absolute gain score of the particular content attribute can be computed based on the average increase or decrease (e.g., by taking an absolute value of the increase or decrease) of the corresponding performance metric when one attribute value of the content attribute is changed to a different attribute value of the content attribute. For example, the absolute gain score for the content attribute of foreground color with five attribute values of red, green, blue, black and white can be determined heuristically with respect to CTR. First, the images in the dataset are grouped based on their foreground color and the average CTR for each of the five attribute values is determined (e.g., the average CTR of all of the images with a red foreground color, the average CTR of all of the images with a green foreground color, etc.). In the example, red has an average CTR of 0.003 and blue has an average CTR of 0.007. Thus, if the foreground color of the image is changed from red to blue, a CTR gain of (0.007−0.003)=0.004 is achieved. Continuing with the example, the absolute gain for each pair of the five attribute values are determined. The absolute gain score is determined by averaging the absolute gain for each pair of the five attribute values. In this regard, the absolute gain score provides a heuristic value indicating the importance of foreground color with respect to CTR.

The KL divergence score of the particular content attribute can be computed based on (1) dividing the corresponding historical performance metrics into performance metric levels, such as two levels corresponding to a high performance metric level (e.g., content assets with a performance metric higher than a 70 percentile) and a low level performance metric level (e.g., content assets with a performance metric below a 30 percentile), (2) determining a probability distribution of the historical performance metrics of the attribute values of the particular content attribute with respect to each of the performance metric levels, and (3) and applying KL divergence between each of the probability distributions to compute the KL divergence score. Referring to the previous example, the five foreground color values will have different frequency distributions in the high CTR level and low CTR level. The KL divergence score computed based on the two distributions (e.g., distribution in the high CTR level and distribution in the low CTR level) provides the KL divergence score, which is a probabilistic value indicating the importance of foreground color with respect to CTR.

The comparative statistical test score of the particular content attribute can be computed using ANOVA (e.g., or the Kruskal-Wallis test) to determine the importance of the particular content attribute on the historical performance metric based on a corresponding effect size (e.g., Eta-squared) of the particular content attribute on the historical performance metric. For instance, the historical performance metric values (e.g., CTR values) of content assets with the corresponding attribute values of the particular content attribute are divided into different groups corresponding to the different attribute values of the particular attribute. After ANOVA is used to confirm that the means of the different groups are significantly different from each other, the effect size of the particular content attribute on the historical performance metric can be determined. The effect size indicates the importance of the content attribute with respect to the performance metric (e.g., a larger effect size indicates a greater importance of the content attribute). Referring to the previous example, five different groups of CTR values are determined corresponding to the historical performance metrics of the five foreground color values. ANOVA is used on the five groups to determine whether the CTR values differ enough to reject the null hypothesis. If the groups differ enough to reject the null hypothesis, the effect size (e.g., the comparative statistical test score) is determined to provide the importance of foreground color with respect to the CTR value.

After the ranked set of content attributes are determined, in certain embodiments, a ranked set of attribute values, or a top subset thereof, is determined by scoring each attribute value using a comparative statistical test, such as ANOVA or a Kruskal-Wallis test, which compares the corresponding historical performance metric of content assets that have the attribute value to the corresponding historical performance metric of the content assets that do not have the attribute value. For example, ANOVA (e.g., or the Kruskal-Wallis test) can be used to calculate an effect size of each attribute value to rank the attribute values of the particular content attribute. The effect size of each attribute value can be determined by applying ANOVA between a group corresponding to the corresponding historical performance metrics of all contents assets with the attribute value to a group corresponding to the corresponding historical performance metrics of all remaining content assets without the attribute value. Continuing with the previous example, foreground color is determined to be an important content attribute based on the impact score. In order to determine if red (e.g., a particular attribute value of foreground color) is an important foreground color value, the dataset corresponding to the CTR values of the content assets of the historical marketing content is divided into two groups. The first groups includes all the assets where red is present as the foreground color and the second group contains all the assets where red is not present as the foreground color). After ANOVA is used to confirm that the means of the different groups are significantly different from each other, the effect size is determined to provide the importance of red as a foreground color with respect to CTR.

In certain embodiments, the ranked set of content attributes and/or the ranked set of attribute values can be displayed to a user (e.g., a marketer) in order to indicate the importance of particular content attributes and particular attribute values to the user. In certain embodiments, a generative artificial intelligence (GenAI) model can be prompted to generate new content based on previously-designed content, the ranked set of content attributes and/or the ranked set of attribute values.

Advantageously, efficiencies of computing and network resources can be enhanced using implementations described herein. In particular, using comparative statistical tests to rank content attribute values of marketing content for a target audience in order to improve KPIs of the marketing content provides for a more efficient use of computing resources (e.g., less computationally expensive, less input/output operations, higher throughput and reduced latency for a network, less packet generation costs, etc.) than conventional methods that require an advertiser to initiate multiple advertising campaigns based on different manually-created marketing content. In this regard, the technology described herein reduces unnecessary computing resources used to initiate multiple advertising campaigns that are developed by manually experimenting and subjectively refining marketing content in order to find marketing content that increases the desired KPIs. Further, the technology described herein conserves network resources, which results in higher throughput, reduced latency and less packet generation costs as fewer packets are sent over the network. Further, in certain embodiments, using computationally inexpensive comparative statistical tests and/or other statistical methods to rank content attribute values of marketing content for a target audience in order to improve KPIs of the marketing content provides for a more efficient use of computing resources (e.g., less computationally expensive, less input/output operations, higher throughput and reduced latency for a network, less packet generation costs, etc.) than methods that require training a predictive model as training a predictive model is cost intensive in terms of computing resources and the prediction accuracy is low when the training dataset is sparse.

### Overview of Exemplary Environments of Using Comparative Statistical Tests to Rank Content Attribute Values for a Target Audience

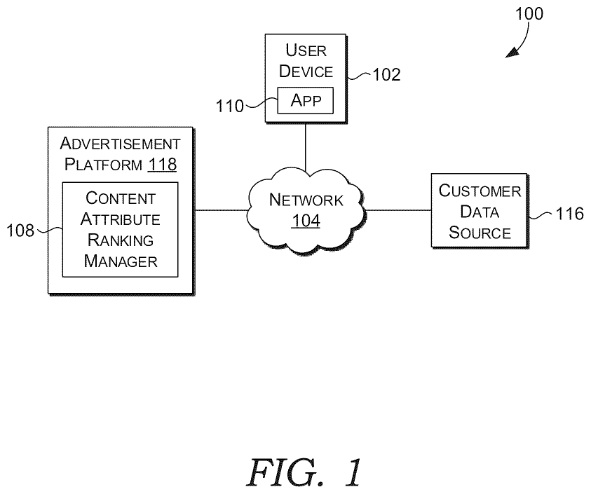

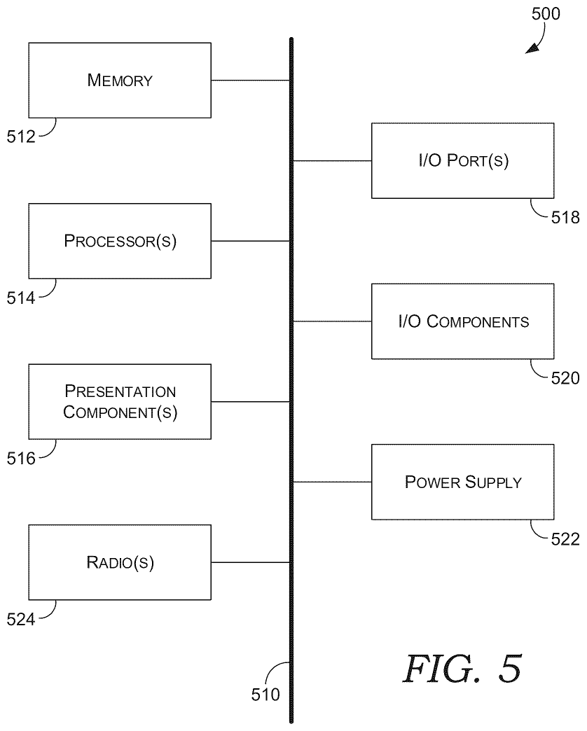

Turning to the figures, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 5.

It should be understood that operating environment 100 shown in FIG. 1 is an example of one suitable operating environment. Among other components not shown, operating environment 100 includes a user device 102, application 110, customer data source 116, network 104, advertisement platform 118, and content attribute ranking manager 108. Each of the components shown in FIG. 1 can be implemented via any type of computing device, such as one or more of computing device 500 described in connection to FIG. 5, for example.

These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

User device 102 can be any type of computing device capable of being operated by an individual(s) (e.g., an advertiser, any user implementing marketing campaigns on behalf of a business, and/or the like). For example, in some implementations, such devices are the type of computing device described in relation to FIG. 5. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media may include computer-readable instructions executable by the one or more processors. The instructions may be embodied by one or more applications, such as application 110 shown in FIG. 1. Application 110 is referred to as a single applications for simplicity, but its functionality can each be embodied by one or more applications in practice.

Application 110 operating on user device 102 can generally be any application capable of facilitating the exchange of information between the user device 102 and advertisement platform 118 and content attribute ranking manager 108 in displaying and exchanging information regarding implementing marketing campaigns, designing content, and/or ranking content attributes and/or attribute values. In some implementations, the application 110 comprises a web application, which can run in a web browser, and could be hosted at least partially server-side (e.g., via content attribute ranking manager 108). In addition, or instead, the application 110 can comprise a dedicated application. In some cases, the application 110 is integrated into the operating system (e.g., as a service). It is therefore contemplated herein that “application” be interpreted broadly.

User device 102 can be a client device on a client-side of operating environment 100, while advertisement platform 118 and content attribute ranking manager 108 can be on a server-side of operating environment 100. Advertisement platform 118 and/or content attribute ranking manager 108 may comprise server-side software designed to work in conjunction with client-side software on user device 102 so as to implement any combination of the features and functionalities discussed in the present disclosure. An example of such client-side software is application 110 on user device 102. This division of operating environment 100 is provided to illustrate one example of a suitable environment, and it is noted there is no requirement for each implementation that any combination of user device 102, advertisement platform 118, or content attribute ranking manager 108 to remain as separate entities.

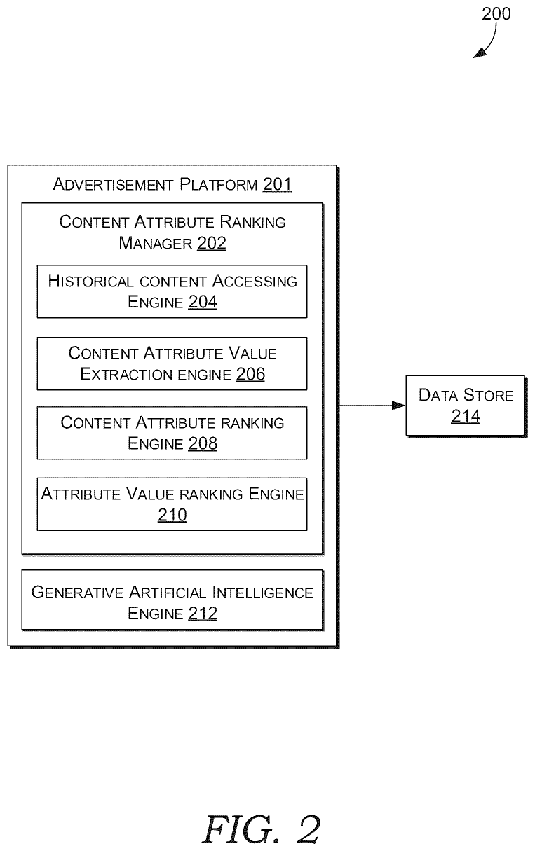

In operation, historical content and corresponding historical performance metrics of the historical content are accessed from customer data source 116 by content attribute ranking manager 108. Attribute values of content attributes are determined by content attribute ranking manager 108 from the historical content using machine learning models trained to extract the attribute values. A ranked set of content attributes, or a top subset thereof, is determined by content attribute ranking manager 108 by scoring each content attribute based on a computed impact of the corresponding attribute values of a particular content attribute on the corresponding historical performance metric. A ranked set of attribute values, or a top subset thereof, is determined by content attribute ranking manager 108 by scoring each attribute value using a comparative statistical test, such as ANOVA or a Kruskal-Wallis test, which compares the corresponding historical performance metric of content assets that have the attribute value to the corresponding historical performance metric of the content assets that do not have the attribute value. The ranked set of content attributes and/or the ranked set of attribute values can be displayed to a user through application 110 via a display screen of the user device 102 in order to indicate the importance of particular content attributes and particular attribute values to the user. In certain embodiments, a GenAI model (e.g., GenAI engine 212 of FIG. 2) of the advertisement platform 118 can generate new marketing content for use by advertisement platform 118 by applying previously-designed content and instructions to generate the new content based on the previously-designed content, the ranked set of content attributes and/or the ranked set of attribute values in a prompt to the GenAI model.

At a high level, advertisement platform 118 serves targeted advertisements and content attribute ranking manager 108 performs various functionality to facilitate efficient and effective ranking of content attribute and/or attribute values. The content attribute ranking manager 108 can communicate with application 110 in order for a user to configure various parameters of a marketing campaign through application 110 via a display screen of the user device 102.

Content attribute ranking manager 108 can be or include a server, including one or more processors, and one or more computer-readable media. The computer-readable media includes computer-readable instructions executable by the one or more processors. The instructions can optionally implement one or more components of content attribute ranking manager 108, described in additional detail below with respect to content attribute ranking manager 202 of FIG. 2. For cloud-based implementations, the instructions on content attribute ranking manager 108 can implement one or more components, and application 110 can be utilized by a user to interface with the functionality implemented on content attribute ranking manager 108. In some cases, application 110 comprises a web browser. In other cases, content attribute ranking manager 108 may not be required. For example, the components of content attribute ranking manager 108 may be implemented completely on a user device, such as user device 102. In this case, content attribute ranking manager 108 may be embodied at least partially by the instructions corresponding to application 110.

Thus, it should be appreciated that content attribute ranking manager 108 may be provided via multiple devices arranged in a distributed environment that collectively provide the functionality described herein. Additionally, other components not shown may also be included within the distributed environment. In addition, or instead, content attribute ranking manager 108 can be integrated, at least partially, into a user device, such as user device 102. Furthermore, content attribute ranking manager 108 may at least partially be embodied as a cloud computing service.

Referring to FIG. 2, aspects of an illustrative content attribute ranking management system 200 are shown, in accordance with various embodiments of the present disclosure. At a high level, the content attribute ranking management system 200 facilitates using comparative statistical tests to rank content attribute values for a target audience in an efficient and effective manner.

As shown in FIG. 2, advertisement platform 201 includes content attribute ranking manager 202 and GenAI engine 212. Content attribute ranking manager 202 includes historical content accessing engine 204, content attribute value extraction engine 205, content attribute ranking engine 206, attribute value ranking engine 208, and attribute value replacement engine 210. The advertisement platform 201 and content attribute ranking manager 202 can communicate with the data store 214. The data store 214 is configured to store various types of information accessible by content attribute ranking manager 202, or other server or component. The foregoing components of content attribute ranking manager 202 can be implemented, for example, in operating environment 100 of FIG. 1. In particular, those components may be integrated into any suitable combination of user devices 102 and/or content attribute ranking manager 108.

In embodiments, data sources (e.g., data store 214, customer data source 116 of FIG. 1), devices (e.g., user device 102 of FIG. 1), advertisement platform 201, and content attribute ranking manager 202 can provide data to the data store 214 for storage, which may be retrieved or referenced by any such component. As such, the data store 214 can store computer instructions (e.g., software program instructions, routines, or services), data and/or models used in embodiments described herein. In some implementations, data store 214 can store information or data received or generated via the various components of advertisement platform 201 and content attribute ranking manager 202 and provides the various components with access to that information or data, as needed. The information in data store 214 may be distributed in any suitable manner across one or more data stores for storage (which may be hosted externally).

The content attribute ranking manager 202 is generally configured to rank content attributes and attribute values. In embodiments, content attribute ranking manager 202, and/or any of its subcomponents, can include rules, conditions, associations, models, algorithms, or the like to rank content attributes and attribute values. For example, content attribute ranking manager 202, and/or any of its subcomponents, may comprise a statistical model, fuzzy logic, neural network, finite state machine, support vector machine, logistic regression, clustering, or machine-learning techniques, similar statistical classification processes, or combinations thereof, to rank content attributes and attribute values.

In certain embodiments, historical content accessing engine 204 accesses historical marketing content and corresponding historical performance metrics of the historical marketing content from data store 214 (e.g., customer data source 116 of FIG. 1). For example, historical marketing content generally includes different content assets (e.g., advertisement designs). Each of the different content assets of the historical marketing content can be divided into different content types, such as text-based content, image-based content, and video-based content.

In certain embodiments, the historical marketing content and corresponding historical performance metrics of the historical marketing content are accessed by historical content accessing engine 204 for a particular target audience. For instance, the particular target audience can correspond to a target audience with particular audience attributes, such as audience attributes corresponding to a particular region, a particular demographic, and/or the like. As a specific example, historical marketing content and corresponding historical performance metrics for male surfers who are located in the United States can be filtered from a larger subset of customer data of a business by historical content accessing engine 204 in order to rank content attribute values for the particular target audience of male surfers who are located in the United States. In some embodiments, if the historical marketing content and corresponding historical performance metrics are sparse for the particular target audience, historical marketing content and corresponding historical performance metrics from a higher level hierarchy with respect to the particular audience attribute can be utilized by historical content accessing engine 204. For example, if the dataset is too sparse to rank content attributes for a target audience of men from California between the ages of 25 and 30, data for men between the ages of 25 and 30 in the whole of United States (e.g., a higher level hierarchy with respect to the particular audience attribute of the California region), data for men from California for a larger age range (e.g., a higher level hierarchy with respect to the particular audience attribute of the 25 to 30 age range), and/or the like can be utilized.

In certain embodiments, content attribute value extraction engine 206 determines attribute values of content attributes from the historical marketing content. For example, from text of the historical marketing content, attribute values of text-based content attributes, such as detected level of readability, detected level of persuasion, detected marketing emotion, detected tone, detected narrative, detected keywords, and/or the like are determined by content attribute value extraction engine 206. In some embodiments, the text-based content attributes extracted from the historical marketing content by content attribute value extraction engine 206 include numerical attribute values, such as detected words count, detected sentence count, detected hash tags count, detected stop words ratio, and/or the like. In some embodiments, the numerical attribute values are categorized into categorical attribute values, such as low word count, medium word count, and high word count, by content attribute value extraction engine 206. From images of the historical marketing content, attribute values of image-based content attributes, such as detected foreground color, detected background color, detected tags, detected scene, detected objects, detected people, detected image styles, and/or the like are determined by content attribute value extraction engine 206. From videos of the historical marketing content, video-based content attributes, such as detected audio type, detected audio genre, detected audio mood, detected camera position, detected lighting conditions, and/or the like are determined by content attribute value extraction engine 206. In some embodiments, machine learning models trained to determine attribute values of content attributes are used by content attribute value extraction engine 206 to determine the attribute values of content attributes from the historical marketing content.

In certain embodiments, content attribute value extraction engine 206 preprocesses the attribute values of content attributes that are extracted from the historical marketing content. In some embodiments, only attribute values which are present in a minimum number of content assets of the historical marketing content are maintained by content attribute value extraction engine 206. For example, if only two content assets are tagged with the foreground color “purple,” the impact of the attribute value of the particular foreground color on CTR may not be able to be determined. As a result, the low-count attribute values (e.g., below a threshold number) are removed from the dataset by content attribute value extraction engine 206.

In some embodiments, correlated attribute values are removed by content attribute value extraction engine 206. For example, an attribute value corresponding to “sky” is extracted from an image and an attribute value corresponding to “blue” is determined to be one of the foreground colors. As these attribute values typically occur together, a correlation analysis is performed by content attribute value extraction engine 206 to determine correlated pairs of attribute values in order to keep only one value from the pair and remove the other. In certain embodiments, correlation analysis can be applied by content attribute value extraction engine 206 that considers the relationship between two attribute values. In certain embodiments, variance inflation factors (VIF) can be applied by content attribute value extraction engine 206 that considers multi-collinearity (e.g., dependency on two or more variables) in order to keep only the attribute values that are independent.

A content attribute ranking engine 208 determines a ranked set of content attributes (e.g., or a top subset thereof) by scoring each content attribute based on a computed impact of the corresponding attribute values of a particular content attribute on the corresponding historical performance metric. In some embodiments, content attribute ranking engine 208 determines ranked list of content attributes (e.g., or a top subset thereof) for each content type, such as text-based content, image-based content, and/or video-based content.

In certain embodiments, the ranked list of content attributes, or top subset thereof, are determined by content attribute ranking engine 208 scoring each content attribute based on a computed impact of the corresponding attribute values of a particular content attribute on the corresponding historical performance metric. The impact score for the particular content attribute can be computed by content attribute ranking engine 208 based on a weighted sum of (1) an absolute gain score; (2) a KL divergence score; and (3) a comparative statistical test score.

In certain embodiments, the absolute gain score of the particular content attribute can be computed based on the average increase or decrease (e.g., by taking an absolute value of the increase or decrease) of the corresponding performance metric when one attribute value of the content attribute is changed to a different attribute value of the content attribute. For example, the absolute gain score for the content attribute of foreground color with five attribute values of red, green, blue, black and white can be determined heuristically with respect to CTR (e.g., as the KPI) by content attribute ranking engine 208. First, the images in the dataset are grouped based on their foreground color and the average CTR for each of the five attribute values is determined (e.g., the average CTR of all of the images with a red foreground color, the average CTR of all of the images with a green foreground color, etc.). In the example, red has an average CTR of 0.003 and blue has an average CTR of 0.007. Thus, if the foreground color of the image is changed from red to blue, a CTR gain of (0.007−0.003)=0.004 is achieved. Continuing with the example, the absolute gain for each pair of the five attribute values are determined by content attribute ranking engine 208. The absolute gain score is determined by averaging the absolute gain for each pair of the five attribute values. In this regard, the absolute gain score provides a heuristic value indicating the importance of foreground color with respect to CTR.

In certain embodiments, the KL divergence score of the particular content attribute is computed by content attribute ranking engine 208 based on (1) dividing the corresponding historical performance metrics into performance metric levels, such as two levels corresponding to a high performance metric level and a low performance metric level, (2) determining a probability distribution of the historical performance metrics of the attribute values of the particular content attribute with respect to each of the performance metric levels, and (3) and applying KL divergence between each of the probability distributions to compute the KL divergence score. For example, content assets with a performance metric higher than the 70 percentile can be defined as a high performance metric level and content assets with a performance metric with values lower than 30 percentile can be defined as a low performance metric level. For each performance metric level, the frequency distribution of the attribute values is determined by content attribute ranking engine 208 based on whether the content asset includes the particular attribute value of the particular content attribute and the corresponding historical performance metric of the content asset. The frequency distribution of the historical performance metrics of the attribute values of the particular content attribute is normalized and converted into a probability distribution with respect to each the performance metric levels by content attribute ranking engine 208. The two probability distributions (e.g., for the two performance metric levels) of the historical performance metrics of the attribute values of the particular content attribute can be compared by content attribute ranking engine 208 using KL divergence and normalized. In this regard, a high KL divergence score for the particular content attribute indicates that the distribution of attribute values in the high KPI range differs significantly from the low KPI range, which is indicates the importance of the particular content attribute. Referring to the previous example, the five foreground color values will have different frequency distributions in the high CTR level and low CTR level. The KL divergence score computed based on the two distributions (e.g., distribution in the high CTR level and distribution in the low CTR level) provides the KL divergence score, which is a probabilistic value indicating the importance of foreground color with respect to CTR.

In certain embodiments, the comparative statistical test score of the particular content attribute is computed by content attribute ranking engine 208 using ANOVA to determine the importance of the particular content attribute on the historical performance metric based on a corresponding effect size (e.g., Eta-squared) of the particular content attribute on the historical performance metric. For instance, the historical performance metric values (e.g., CTR values) of content assets with the corresponding attribute values of the particular content attribute are divided into different groups corresponding to the different attribute values of the particular attribute by content attribute ranking engine 208. ANOVA is used by content attribute ranking engine 208 to calculate the means and standard deviations of the different groups, as well as the number of historical performance metric in each of the different groups to determine an F-statistic value. The F-statistic value compares the variance within each group to the overall variance of the means of the different groups. The null hypothesis of ANOVA is that all the group means are equal and the alternative hypothesis is that the means of the groups differ significantly. In certain instances, a large difference in the means of the different groups combined with small variances within the different groups indicates a greater difference between the different groups, thereby leading to the rejection of the null hypothesis. In certain instances, after ANOVA is used to confirm that the means of the different groups are significantly different from each other, the effect size of the particular content attribute on the historical performance metric can be determined by content attribute ranking engine 208. The effect size indicates the amount of variance in the performance metric values based on the different groupings that correspond to the different attribute values of the particular content attribute. The effect size (e.g., the comparative statistical test score) indicates the importance of the content attribute with respect to the performance metric (e.g., a larger effect size indicates a greater importance of the content attribute). Referring to the previous example of foreground color, five different groups of CTR values are determined corresponding to the five foreground color values. ANOVA is used on the five groups to determine whether the CTR values differ enough to reject the null hypothesis. If the groups differ enough to reject the null hypothesis, the effect size (e.g., the comparative statistical test score) is determined to provide the importance of foreground color with respect to the CTR value. In certain embodiments, the Kruskal-Wallis test is used by content attribute ranking engine 208 instead of ANOVA.

In certain embodiments, the impact score of each content attribute is determined by content attribute ranking engine 208 based on a weighted sum of the absolute gain score, the KL divergence score, and the comparative statistical test score for the particular content attribute, where the comparative statistical test score has the greatest weight (e.g., 50%), the KL divergence has the next greatest weight (e.g., 30%), and the absolute gain score has the lowest weight (e.g., 20%).

In certain embodiments, an attribute value ranking engine 210 determines a ranked set of attribute values, or a top subset thereof, by scoring each attribute value using a comparative statistical test, such as ANOVA or a Kruskal-Wallis test, that compares the corresponding historical performance metric of each content asset with the attribute value to the corresponding historical performance metric of each remaining content asset without the attribute value.

In certain embodiments, ANOVA (e.g., or the Kruskal-Wallis test) is used by attribute value ranking engine 210 to calculate an effect size, referred to as a “presence-absence score,” of each attribute value to rank the attribute values of the particular content attribute. The effect size of each attribute value can be determined by attribute value ranking engine 210 by applying ANOVA between a group corresponding to the corresponding historical performance metrics of all contents assets with the attribute value to a group corresponding to the corresponding historical performance metrics of all remaining content assets without the attribute value. Continuing with the previous example, in order to determine if red is an important foreground color value, the dataset corresponding to the CTR values of the content assets of the historical marketing content is divided into two groups by attribute value ranking engine 210. The first group includes all the assets where red is present as the foreground color (e.g., the presence group) and the second group contains all the assets where red is not present as the foreground color (e.g., the absence group). ANOVA is applied by attribute value ranking engine 210 to the two sets of CTR values. In this regard, ANOVA is used by attribute value ranking engine 210 to determine if the average CTR of the presence group is differ enough from that of the absence group to reject the null hypothesis. If the groups differ enough to reject the null hypothesis, the effect size is determined by attribute value ranking engine 210 to provide the importance of red as a foreground color with respect to the CTR value. This process is iterated over all the foreground color values by attribute value ranking engine 210. The attribute values are ranked by attribute value ranking engine 210 based on the effect size (e.g., presence-absence score) of each of the attribute values of the particular content attribute. In certain embodiments, the Kruskal-Wallis test is used by attribute value ranking engine 210 instead of ANOVA.

In certain embodiments, the ranked set of content attributes and/or the ranked set of attribute values can be displayed to a user (e.g., through application 110 via a display screen of the user device 102 of FIG. 1) in order to indicate the importance of particular content attributes and particular attribute values to the user. In this regard, low performing attribute values (e.g., with respect to the historical performance metrics) can be replaced with high performing attribute values. In certain embodiments, the ranked set of content attributes and/or the ranked set of attribute values can be used to generate variations of marketing content in order to increase the likelihood of the KPI of the marketing content during an advertising campaign implemented via advertisement platform 201. For instance, a GenAI engine 212 (e.g., Firefly, ChatGPT, etc.) can generate new marketing content (e.g., text-based content, image-based content, and/or video-based content) by applying previously-designed content and instructions to generate the new content based on the previously-designed content, the ranked set of content attributes and/or the ranked set of attribute values in a prompt to GenAI engine 212.

### Exemplary Implementations of Using Comparative Statistical Tests to Rank Content Attribute Values for a Target Audience

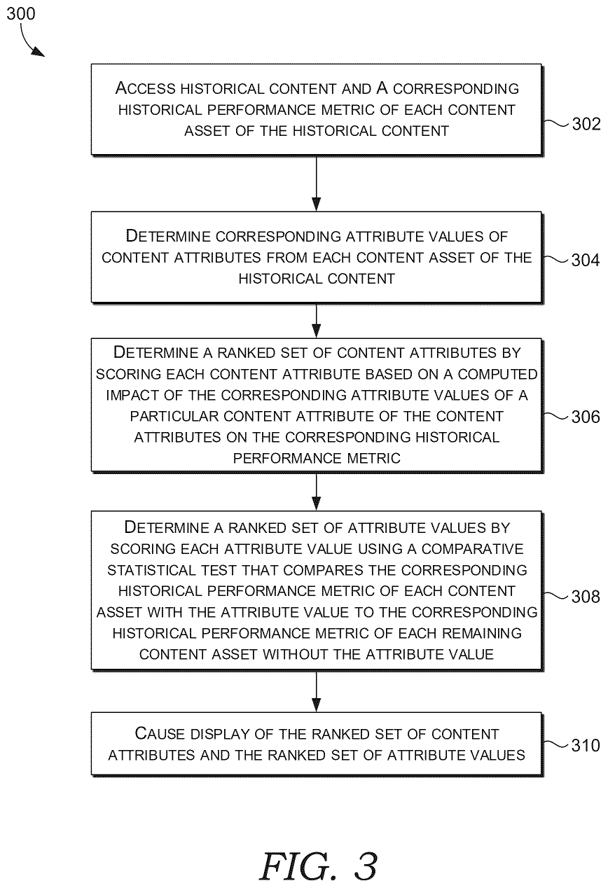

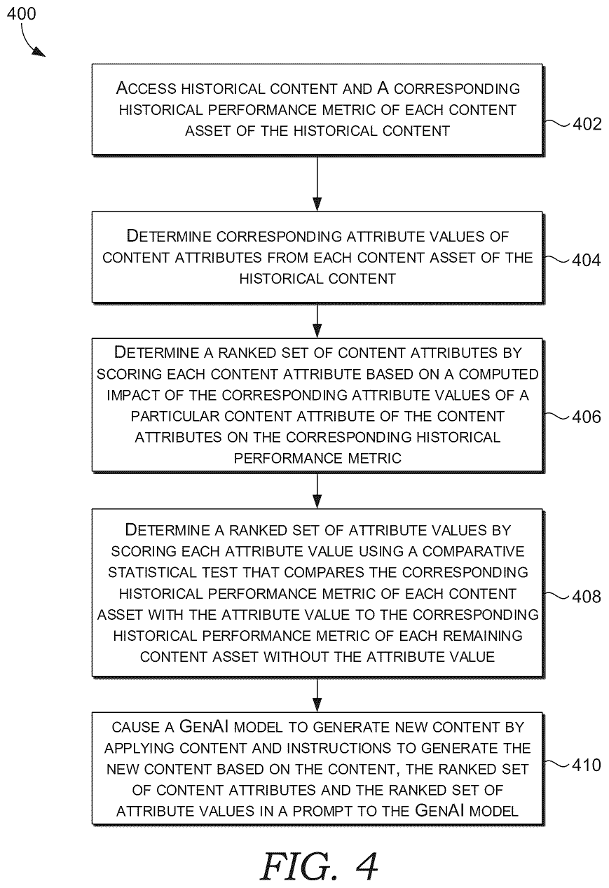

With reference now to FIGS. 3-4, flow diagrams are provided showing exemplary methods 300-400 related to using comparative statistical tests to rank content attribute values for a target audience, in accordance with embodiments of the present technology. Each block of methods 300-400 comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. The method flows of FIGS. 3-4 are exemplary only and not intended to be limiting. As can be appreciated, in some embodiments, method flows 300-400 can be implemented, at least in part, to facilitate using comparative statistical tests to rank content attribute values for a target audience.

Turning initially to FIG. 3, a flow diagram is provided showing an embodiment of a method 300 for using comparative statistical tests to rank content attribute values for a target audience in accordance with embodiments described herein. Initially, at block 302, historical content and a corresponding historical performance metric of each content asset of the historical content are accessed. In certain embodiments, the historical content and corresponding historical performance metrics of the historical marketing content are accessed based on a particular target audience.

At block 304, corresponding attribute values of content attributes from each content asset of the historical content are determined. In certain embodiments, the corresponding attribute values of the content attributes are determined from each content asset of the historical content using a machine learning model trained to extract at least one of attribute values of text-based content attributes from text-based content, image-based content attributes from image-based content, or video-based content attributes from video-based content. In certain embodiments, the corresponding attribute values of the content attributes are preprocessed to remove attribute values that are included in less than a minimum number of content assets of the historical marketing content. In certain embodiments, the corresponding attribute values of the content attributes are preprocessed to remove correlated attribute values using variance inflation factors At block 306, a ranked set of content attributes is determined by scoring each content attribute based on a computed impact of the corresponding attribute values of a particular content attribute of the content attributes on the corresponding historical performance metric. In certain embodiments, the computed impact of the corresponding attribute values of the particular content attribute is determined based on a weighted sum of (1) an absolute gain score; (2) a KL divergence score; and (3) a comparative statistical test score. In certain embodiments, the absolute gain score is determined based on the average change (e.g., by taking an absolute value of the increase or decrease) of the corresponding historical performance metric when one corresponding attribute value of the particular content attribute is changed to a different corresponding attribute value of the particular content attribute. In certain embodiments, the KL divergence score is determined based on (1) dividing the corresponding historical performance metrics into performance metric levels (2) determining a corresponding probability distribution of the corresponding historical performance metrics of the attribute values of the particular content attribute with respect to each of the performance metric levels, and (3) and applying KL divergence between each corresponding probability distribution. In certain embodiments, the comparative statistical test score is determined using at least one of ANOVA or the Kruskal-Wallis test to compute an effect size based on different groups corresponding to each the corresponding attribute values of the particular content attribute.

At block 308, a ranked set of attribute values is determined by scoring each attribute value using a comparative statistical test that compares the corresponding historical performance metric of each content asset with the attribute value to the corresponding historical performance metric of each remaining content asset without the attribute value. In certain embodiments, the comparative statistical test corresponds to least one of ANOVA or a Kruskal-Wallis test.

At block 310, the ranked set of content attributes and the ranked set of attribute values are displayed to a user (e.g., a marketer). In this regard, low performing attribute values (e.g., with respect to the historical performance metrics) can be replaced with high performing attribute values to increase the corresponding KPI of the new content. In certain embodiments, the user generates new content by applying content and instructions to generate the new content based on the content, the ranked set of content attributes and the ranked set of attribute values in a prompt to a GenAI model.

Turning now to FIG. 4, a flow diagram is provided showing an embodiment of a method 400 for using comparative statistical tests to rank content attribute values for a target audience in accordance with embodiments described herein. Initially, at block 402, historical content and a corresponding historical performance metric of each content asset of the historical content are accessed. In certain embodiments, the historical content and corresponding historical performance metrics of the historical marketing content are accessed based on a particular target audience.

At block 404, corresponding attribute values of content attributes from each content asset of the historical content are determined. In certain embodiments, the corresponding attribute values of the content attributes are determined from each content asset of the historical content using a machine learning model trained to extract at least one of attribute values of text-based content attributes from text-based content, image-based content attributes from image-based content, or video-based content attributes from video-based content. In certain embodiments, the corresponding attribute values of the content attributes are preprocessed to remove attribute values that are included in less than a minimum number of content assets of the historical marketing content. In certain embodiments, the corresponding attribute values of the content attributes are preprocessed to remove correlated attribute values using variance inflation factors At block 406, a ranked set of content attributes is determined by scoring each content attribute based on a computed impact of the corresponding attribute values of a particular content attribute of the content attributes on the corresponding historical performance metric. In certain embodiments, the computed impact of the corresponding attribute values of the particular content attribute is determined based on a weighted sum of (1) an absolute gain score; (2) a KL divergence score; and (3) a comparative statistical test score. In certain embodiments, the absolute gain score is determined based on the average change (e.g., by taking an absolute value of the increase or decrease) of the corresponding historical performance metric when one corresponding attribute value of the particular content attribute is changed to a different corresponding attribute value of the particular content attribute. In certain embodiments, the KL divergence score is determined based on (1) dividing the corresponding historical performance metrics into performance metric levels (2) determining a corresponding probability distribution of the corresponding historical performance metrics of the attribute values of the particular content attribute with respect to each of the performance metric levels, and (3) and applying KL divergence between each corresponding probability distribution. In certain embodiments, the comparative statistical test score is determined using at least one of ANOVA or the Kruskal-Wallis test to compute an effect size based on different groups corresponding to each the corresponding attribute values of the particular content attribute.

At block 408, a ranked set of attribute values is determined by scoring each attribute value using a comparative statistical test that compares the corresponding historical performance metric of each content asset with the attribute value to the corresponding historical performance metric of each remaining content asset without the attribute value. In certain embodiments, the comparative statistical test corresponds to least one of ANOVA or a Kruskal-Wallis test.

At block 410, a GenAI model generates new content by applying content and instructions to generate the new content based on the content, the ranked set of content attributes and the ranked set of attribute values in a prompt to the GenAI model. In this regard, low performing attribute values (e.g., with respect to the historical performance metrics) can be replaced with high performing attribute values by the GenAI model to increase the corresponding KPI of the new content.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 5 in particular, an exemplary operating environment for implementing aspects of the technology described herein is shown and designated generally as computing device 500. Computing device 500 is just one example of a suitable computing environment and is not intended to suggest any limitation as to the scope of use or functionality of the technology described herein. Neither should the computing device 500 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 5, computing device 500 includes a bus 510 that directly or indirectly couples the following devices: memory 512, one or more processors 514, one or more presentation components 516, input/output (I/O) ports 518, I/O components 520, an illustrative power supply 522, and a radio(s) 524. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 5 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 5 and refer to “computer” or “computing device.”

Computing device 500 typically includes a variety of computer-readable media. Computer-readable media can be any available media that can be accessed by computing device 500 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 512 includes computer storage media in the form of volatile and/or nonvolatile memory. The memory 512 may be removable, non-removable, or a combination thereof. Exemplary memory includes solid-state memory, hard drives, and optical-disc drives. Computing device 500 includes one or more processors 514 that read data from various entities such as bus 510, memory 512, or I/O components 520. Presentation component(s) 516 present data indications to a user or other device. Exemplary presentation components 516 include a display device, speaker, printing component, and vibrating component. I/O port(s) 518 allow computing device 500 to be logically coupled to other devices including I/O components 520, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 514 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 500. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 500. The computing device 500 may be equipped with depth cameras, such as stereoscopic camera systems, infrared camera systems, RGB camera systems, and combinations of these, for gesture detection and recognition. Additionally, the computing device 500 may be equipped with accelerometers or gyroscopes that enable detection of motion. The output of the accelerometers or gyroscopes may be provided to the display of the computing device 500 to render immersive augmented reality or virtual reality.

A computing device may include radio(s) 524. The radio 524 transmits and receives radio communications. The computing device may be a wireless terminal adapted to receive communications and media over various wireless networks. Computing device 500 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive. The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

1. A computing system comprising:
a processor; and
a non-transitory computer-readable medium having stored thereon instructions that when executed by the processor, cause the processor to perform operations including:
accessing, by a historical content accessing engine, historical content and a corresponding historical performance metric of each content asset of the historical content;
determining, by a content attribute value extraction engine, corresponding attribute values of content attributes from each content asset of the historical content by:
training a machine learning model to extract at least one of attribute values of text-based content attributes from text-based content, image-based content attributes from image-based content, or video-based content attributes from video-based content; and
detecting the corresponding attribute values of the content attributes from each content asset of the historical content using the machine learning model;
determining, by a content attribute ranking engine, a ranked set of content attributes by scoring each content attribute based on a computed impact of the corresponding attribute values of a particular content attribute of the content attributes on the corresponding historical performance metric using a weighted sum of an absolute gain score, a Kullback-Leibler (KL) divergence score, and a comparative statistical test score;
determining, by an attribute value ranking engine, a ranked set of attribute values by scoring each attribute value using a comparative statistical test that compares the corresponding historical performance metric of each content asset with the attribute value to the corresponding historical performance metric of each remaining content asset without the attribute value; and
causing display of the ranked set of content attributes and the ranked set of attribute values.

2. The computing system of claim 1, the operations further including:
generating new content by applying content and corresponding instructions to generate the new content based on the content, the ranked set of content attributes and the ranked set of attribute values in a prompt to a generative artificial intelligence model.

3. The computing_system of claim 1, wherein the comparative statistical test corresponds to least one of an analysis of variance (ANOVA) or a Kruskal-Wallis test.

4. (canceled)

5. The computing system of claim 1, wherein the absolute gain score is determined based on an average change of the corresponding historical performance metric when one corresponding attribute value of the particular content attribute is changed to a different corresponding attribute value of the particular content attribute.

6. The computing_system of claim 1, wherein the KL divergence score is determined based on (1) dividing the corresponding historical performance metric into performance metric levels (2) determining a corresponding probability distribution of the corresponding historical performance metric of the corresponding attribute values of the particular content attribute with respect to each of the performance metric levels, and (3) and applying KL divergence between each corresponding probability distribution.

7. The computing system of claim 1, wherein the comparative statistical test score can be determined using at least one of an analysis of variance (ANOVA) or a Kruskal-Wallis test to compute an effect size based on different groups corresponding to each the corresponding attribute values of the particular content attribute.

8. The computing system of claim 1, wherein the historical content and corresponding historical performance metrics of the historical content are accessed based on a particular target audience.

9. The computing system of claim 1, wherein the text-based content attributes comprise readability, persuasion strategy, content emotions, tones, narratives, keywords, words count, sentences count, hash tags count and stop words ratio, the image-based content attributes comprise foreground colors, background colors, tags, scenes, objects, people categories and image styles, and the video-based content attributes comprise audio type, audio genre, audio mood, camera position and lighting conditions.

10. The computing system of claim 1, the operations further including:
preprocessing the corresponding attribute values of the content attributes to remove the corresponding_attribute values that are included in less than a minimum number of content assets of the historical content.

11. The computing system of claim 1, the operations further including:
preprocessing the corresponding attribute values of the content attributes to remove correlated attribute values using variance inflation factors.

12. A non-transitory computer-readable medium storing executable instructions, which when executed by a processing device, cause the processing device to perform operations comprising:
accessing, by a historical content accessing engine, historical content and a corresponding historical performance metric of each content asset of the historical content;
determining, by a content attribute value extraction engine, corresponding attribute values of content attributes from each content asset of the historical content;
determining, by a content attribute ranking engine, a ranked set of content attributes by scoring each content attribute based on a computed impact of the corresponding attribute values of a particular content attribute of the content attributes on the corresponding historical performance metric using a weighted sum of an absolute gain score, a Kullback-Leibler (KL) divergence score, and a comparative statistical test score;
determining, by an attribute value ranking engine, a ranked set of attribute values by scoring each attribute value using a comparative statistical test that compares the corresponding historical performance metric of each content asset with the attribute value to the corresponding historical performance metric of each remaining content asset without the attribute value; and
causing a generative artificial intelligence model to generate new content by applying content and instructions to generate the new content based on the content, the ranked set of content attributes and the ranked set of attribute values in a prompt to the generative artificial intelligence model.

13. The non-transitory computer-readable medium of claim 12, wherein the comparative statistical test corresponds to least one of an analysis of variance (ANOVA) or a Kruskal-Wallis test.

14. The non-transitory computer-readable medium of claim 12, the operations further comprising:
determining the computed impact of the corresponding attribute values of the particular content attribute based on the weighted sum of:
(1) the absolute gain score computed based on an average change of the corresponding historical performance metric when one corresponding attribute value of the particular content attribute is changed to a different corresponding attribute value of the particular content attribute;
(2) the KL divergence score computed based on (1) dividing the corresponding historical performance metric into performance metric levels (2) determining a corresponding probability distribution of the corresponding historical performance metric of attribute values of the particular content attribute with respect to each of the performance metric levels, and (3) and applying KL divergence between each corresponding probability distribution; and
(3) the comparative statistical test score computed using at least one of an analysis of variance (ANOVA) or a Kruskal-Wallis test to compute an effect size based on different groups corresponding to each the corresponding attribute values of the particular content attribute.

15. The non-transitory computer-readable medium of claim 12, wherein the historical content and corresponding historical performance metrics of the historical content are accessed based on a particular target audience.

16. The non-transitory computer-readable medium of claim 12, operations further comprising:
determining the corresponding attribute values of the content attributes from each content asset of the historical content using a machine learning model trained to extract at least one of attribute values of text-based content attributes from text-based content, image-based content attributes from image-based content, or video-based content attributes from video-based content.

17. The non-transitory computer-readable medium of claim 12, the operations further comprising:
preprocessing the corresponding attribute values of the content attributes to remove attribute values that are included in less than a minimum number of content assets of the historical content.

18. The non-transitory computer-readable medium of claim 12, the operations further comprising:
preprocessing the corresponding attribute values of the content attributes to remove correlated attribute values using variance inflation factors.

19. A computer-implemented method comprising:
accessing, by a historical content accessing engine, historical content and a corresponding historical performance metric of each content asset of the historical content;
determining, by a content attribute value extraction engine, corresponding attribute values of content attributes from each content asset of the historical content;
determining, by a content attribute ranking engine, a ranked set of content attributes by scoring each content attribute based on a computed impact of the corresponding attribute values of a particular content attribute of the content attributes on the corresponding historical performance metric based on a weighted sum of an absolute gain score, a Kullback-Leibler (KL) divergence score, and a comparative statistical test score;
determining, by an attribute value ranking engine, a ranked set of attribute values by scoring each attribute value using a comparative statistical test that compares the corresponding historical performance metric of each content asset with the attribute value to the corresponding historical performance metric of each remaining content asset without the attribute value; and
causing display of the ranked set of content attributes and the ranked set of attribute values.

20. The computer-implemented method of claim 19, further comprising:
determining the absolute gain score based on an average change of the corresponding historical performance metric when one corresponding attribute value of the particular content attribute is changed to a different corresponding attribute value of the particular content attribute;
determining the KL divergence score based on (1) dividing the corresponding historical performance metric into performance metric levels (2) determining a corresponding probability distribution of the corresponding historical performance metric of attribute values of the particular content attribute with respect to each of the performance metric levels, and (3) and applying KL divergence between each corresponding probability distribution; and
determining the comparative statistical test score using at least one of an analysis of variance (ANOVA) or a Kruskal-Wallis test to compute an effect size based on different groups corresponding to each the corresponding attribute values of the particular content attribute.
